(19) United States
(12) Patent Application Publication
(10) Pub. No.: US 2015/0372404 A1
(43) Pub. Date: Dec. 24, 2015

(54) Programming Connector for Electrically Connecting an External Electronic Device to Circuit Board Containing a Programmable Component

(71) Applicant: ABB TECHNOLOGY AG, Zurich (CH)

(72) Inventors: Francesco MATOCCI, Pistoia (IT); Filippo VERNIA, La Spezia (IT)

(21) Appl. No.: 14/766,610

(22) PCT Filed: Feb. 27, 2013
(86) PCT No.: PCT/IT2013/000058

§ 371 Date: Aug. 7, 2015

(51) Int. Cl. H01R 12/70

(52) U.S. Cl. CPC H01R 12/7076; H01R 12/7005

(57) ABSTRACT

The device for electrically connecting a circuit board to an external programmer comprises a support (3) carrying a plurality of retractable electrical contacts (5). The retractable electrical contacts are positioned according to a predetermined arrangement corresponding to the position of conductive pads produced on a circuit board, on which at least one component to be programmed is located. The device also comprises a connector (9) electrically connected to the retractable electrical contacts.

### TECHNICAL FIELD

The invention relates to a device for connecting an external electronic device to electronic equipment, and more precisely to a circuit board containing at least one programmable component or device.

### BACKGROUND ART

Many types of electronic equipment contain one or more internal programmable devices, for example a microcontroller, a microprocessor, a DSP or other devices. These devices are normally assembled and programmed after assembly.

In some cases programming takes place in a location different from the assembly location. In some cases it may also be necessary to reprogram the device, for example to update the software or firmware.

Programming is carried out via a programmer, i.e. an external unit provided with a cable and with a first programming connector, which is coupled to a second connector soldered on the circuit board on which the electronic component to be programmed is located. The connector on the board is connected to the terminals of the component to be programmed.

This requires each board on which a component to be programmed is located to be provided with its own connector. The connector has a considerable impact on the total cost of the circuit board.

### SUMMARY OF THE INVENTION

According to one aspect, a device is provided for electrical connection of a circuit board to an external programmer, comprising: a support; a plurality of retractable electrical contacts positioned according to a predetermined arrangement and carried by the support, and a connector electrically connected to the retractable electrical contacts.

The retractable electrical contacts are arranged according to a predetermined position corresponding to the arrangement of solder pads present on the circuit board and in electrical connection with the terminals or pins for programming the programmable electronic component supported on the board. The need for an electrical connector for each board with related wiring is thus avoided. The number and position of the retractable electrical contacts are configured on the support so as to correspond to the pads of the board supporting the component to be programmed and electrical connection with the programmer is obtained via the retractable electrical contacts, the connector of the device containing the retractable electrical contacts and the connector of the programmer.

Elimination of a connector on the circuit board leads to a saving of materials and of assembly costs.

The same support can, if necessary, be configured in a variable manner, by modifying the number and position of the retractable electrical contacts, for example to adapt to different circuit boards, having a different number and/or different arrangement of solder pads.

Advantageously, members can be provided to prevent incorrect coupling between the retractable electrical contacts and the circuit board. For example, members that define a form-fitting coupling can be provided, so that the retractable electrical contacts and the pads can approach each other only with a univocal orientation of the device containing the retractable electrical contacts.

In some embodiments, this can be obtained via a pin or preferably at least one pair of pins parallel to the retractable electrical contacts and preferably longer than the latter. The pins are inserted in corresponding holes of the circuit board. Coupling between the connection device and the circuit board is therefore only possible when these two elements assume a univocally defined mutual position.

According to a different aspect, a circuit board is provided comprising at least one electronic component or device programmable via an external programmer, comprising a plurality of solder pads, corresponding to programming terminals of the programmable electronic component, positioned according to a predetermined arrangement.

According to a further aspect, electronic equipment is provided containing at least one circuit board as defined above, wherein the pads of the circuit board are accessible from the outside to enable programming of the programmable electronic component.

Further advantageous features of the method according to the invention will be described below and/or defined in the appended claims. The invention specifically relates to a method of managing communication between several devices connected to a transmission channel, which comprises one or more of the rules, methods or features described below and in the appended claims.

### BRIEF DESCRIPTION OF THE DRAWINGS

The invention will be better understood by following the description and accompanying drawing, which shows non-limiting practical embodiments of the invention. More in particular, in the drawing:

FIG. 1 shows an axonometric schematic view of a device according to the invention, associated with a programmer and with a circuit board containing a component to be programmed;

FIG. 2 shows a side view, according to II-II, of FIG. 3, of the device coupled to the circuit board;

FIG. 3 shows a plan view of the device of FIG. 2;

FIG. 4 shows a longitudinal section of a retractable contact;

FIG. 5 shows a front view of a portion of housing of an electronic device containing the board to be programmed, visible and accessible through an opening of the casing;

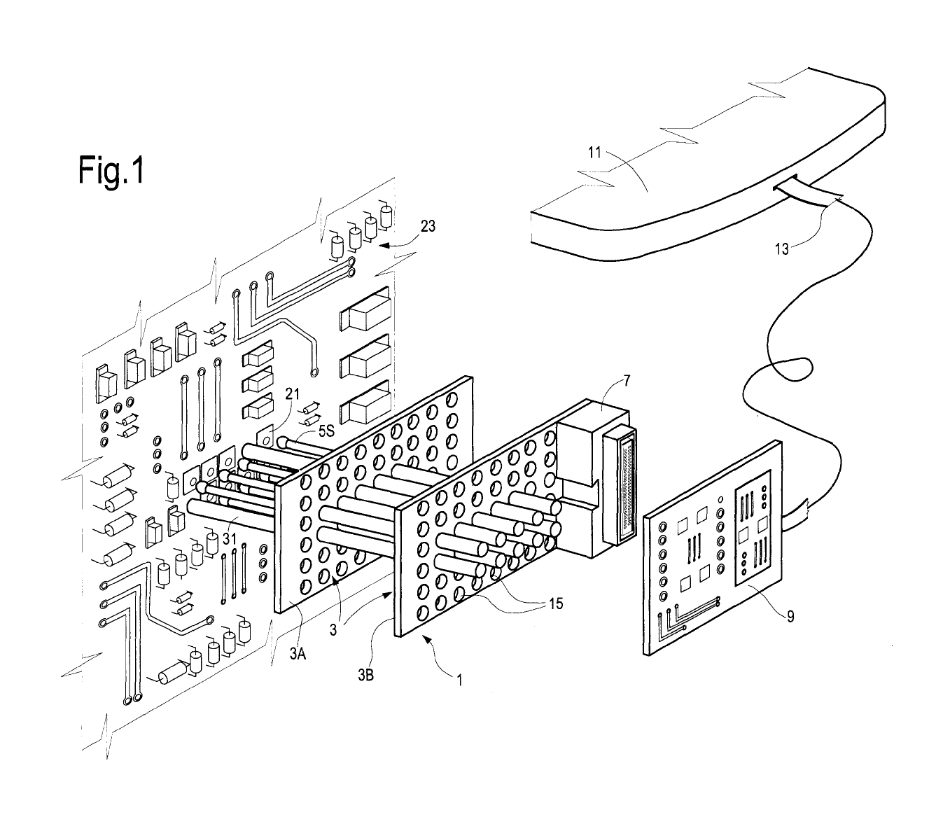

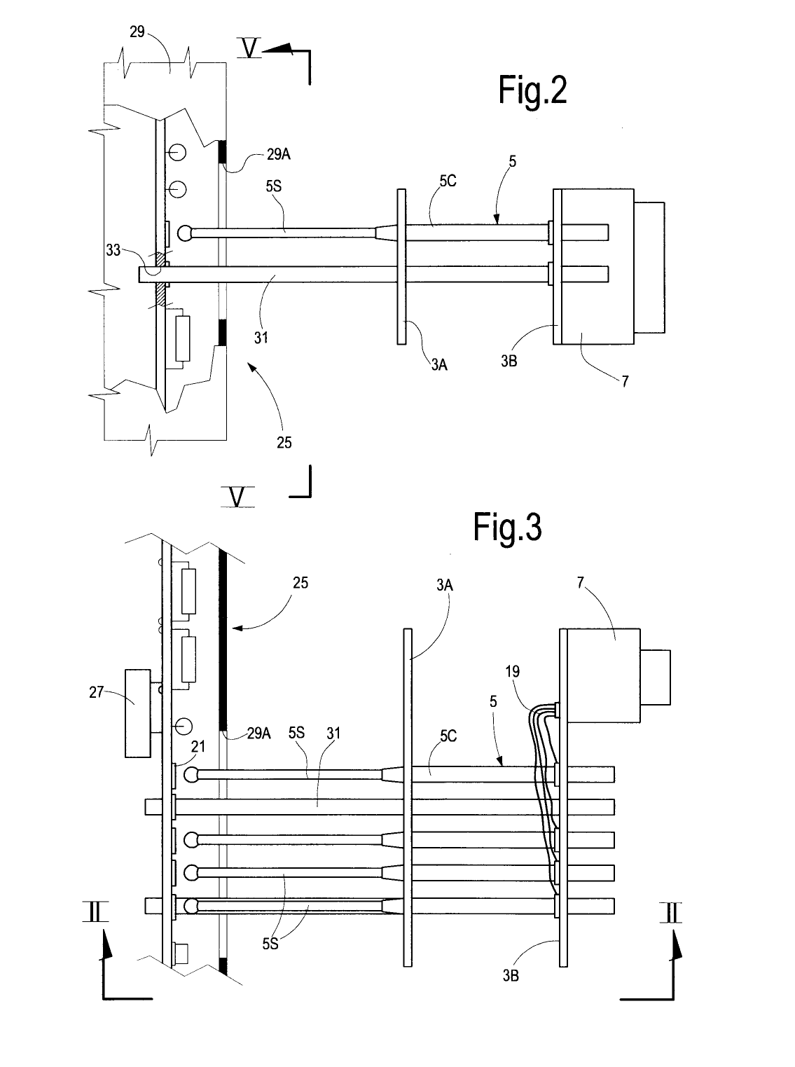

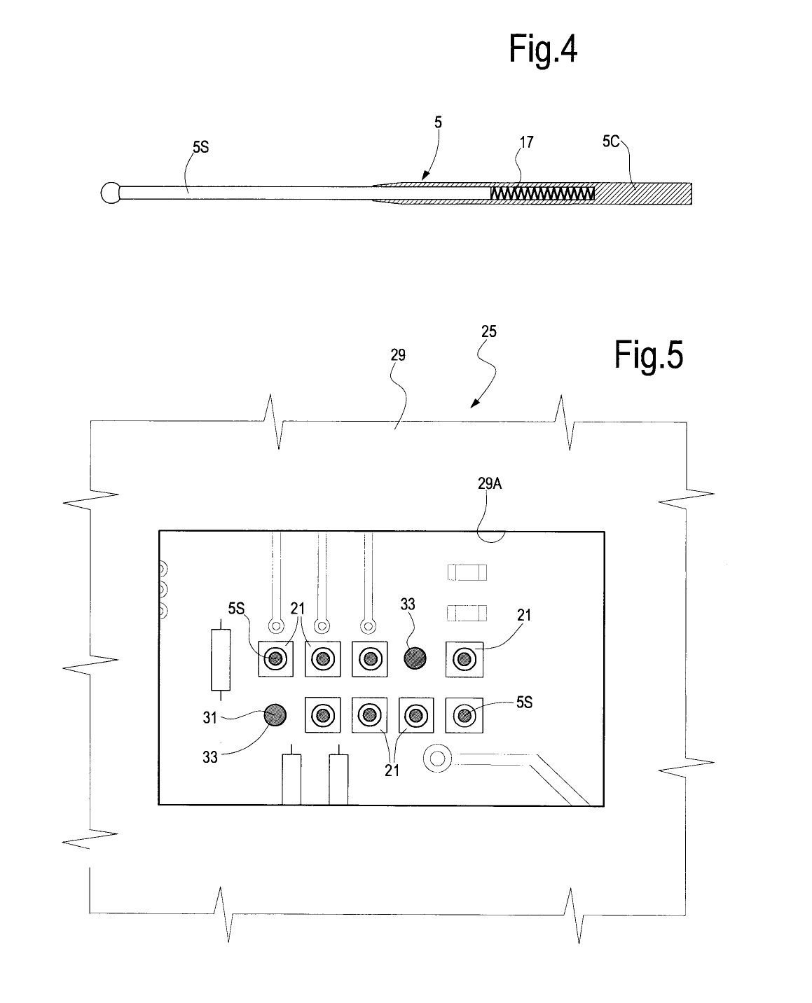

### DETAILED DESCRIPTION OF AN EMBODIMENT OF THE INVENTION

The device, indicated as a whole with 1, comprises a support 3 to which retractable electrical contacts 5 and a connector 7 are connected. The connector 7 is intended to be coupled to a connector 9 of an external programmer 11. In some embodiments the programmer 11 is connected to the connector 9 via a cable 13.

In some embodiments, the support comprises two plates 3A and 3B. In other embodiments the support can be structured differently, for example with a single block in which the retractable electrical contacts are housed.

In some embodiments, each plate 3A, 3B of the support 3 comprises a plurality of holes 15, preferably arranged according to a two-dimensional array. In the example shown, the plates 3A, 3B have a number of holes greater than the number of retractable electrical contacts, so as to be able to position the retractable electrical contacts in a different way, according to the position in which the terminals of the components to be programmed are located, as will be clarified in greater detail below.

In some embodiments each retractable electrical contact 5 comprises an external casing, for example cylindrical in shape, indicated with 5C, and a rod 5S housed inside the casing 5C and coaxial therewith. The rod 5S is elastically biased via an elastic member, such as a spring 17. In this way, each rod 5S is biased toward an extracted position in which it projects with a distal portion thereof from the respective casing 5C. Each retractable electrical contact 5 is electrically connected via electrical conductors 19 to a respective terminal of the connector 7.

The retractable electrical contacts 5 are arranged on the support according to a predetermined arrangement, corresponding to the arrangement of respective solder pads 21 located on a circuit board 23 of electronic equipment 25, which must be programmed via programmer 11.

In the same electronic equipment 25 there can be one or more circuit boards 23 provided with respective pads 21. The pads 21 correspond to respective pins or terminals of a programmable electronic component, for example a microcontroller, indicated schematically with 27.

The number and the position of the retractable electrical contacts 5 on the support of the device 1 correspond to the number and to the position of the solder pads 21 and therefore to the number and to the position of the terminals or pins of the component to be programmed.

By moving the device 1 with the retractable electrical contacts 5 toward the solder pads 21 made accessible, for example, through an opening 29A of a housing 29 in which the circuit board 23 is located, the respective pads 21 can be electrically connected with the same number of retractable electrical contacts 5. These latter, being connected individually to contacts of the connector 7, can in turn be connected to the programmer 11 via the connector 9 and the cable 13 of this latter.

In this way, with a single pair of connectors 7, 9, it is possible to program a very large number of electronic devices, making it unnecessary to mount a connector on each board on which a component to be programmed is arranged.

In some embodiments, means are provided to prevent incorrect coupling between the device 1 and the circuit board 23.

For this purpose, in some embodiments the support 3 is provided, as well as with a plurality of retractable electrical contacts 5, with one or preferably two or more non-retractable pins 31, arranged parallel to one another and parallel to the retractable electrical contacts 5. Preferably, the pins 31 project from the support 3 more than the rods 5S of retractable electrical contacts 5. In this way, when the device 1 is moved toward the circuit board 23, the pins 31 reach the circuit board 23 before the retractable electrical contacts 5. In order for the retractable electrical contacts 5 to come into electrical contact with the pads 21, the pins 31 must be inserted into holes 33 provided on the circuit board 23. The holes 33 are advantageously arranged so that the pins 31 can be inserted therein only when the device 1 has been correctly oriented with respect to the circuit board 23. When the device 1 is rotated through 180° with respect to the correct position, for example, the pins 31 impact against the circuit board 23 and/or against the pads 21 arranged thereon and therefore the retractable electrical contacts 5S cannot come into contact and establish a connection between the pads 21 and the programmer 11.

In other embodiments, other systems can be provided to ensure correct orientation of the device 1 with respect to the board, such as a form of the support 3 that must correspond to a form of an access hole in the housing in which the circuit board to be programmed is located.

In the example shown, the circuit board 23 has an arrangement of eight pads corresponding to eight pins of a programmable device mounted on the circuit board 23, for example on the face opposite the one on which the pads 21 are located. The pads 21 are arranged according to two rows each containing four pads and one through hole. In one row the through hole is at the end, while in the other row the through hole 33 is located in an intermediate position between the pads. Correspondingly, the pins 31 and the retractable electrical contacts 5 are arranged on the support 3 of the device 1 so that there is only one possible coupling position between the device 1 and the circuit board 23.

The pins 31 and the holes 33 also act as guides to facilitate movement of the device 1 and the circuit board 23 toward each other so that the retractable electrical contacts 5 gradually and correctly move closer to the respective pads 21. The movement of the device 1 and the circuit board 23 toward each other carries all the distal ends of the rods 5S of the retractable electrical contacts into contact with the respective pads 21.

Using the device 1 described above it is therefore possible to program a plurality of programmable components placed inside the same number of pieces of electronic equipment, using the programmer 11 with its connector 9 and the device 1 with the connector 7 and the retractable electrical contacts 5, by providing on each circuit board containing an electronic component to be programmed only solder pads 23 and through holes 33, eliminating the need for a connector 7 for each circuit board 23, and consequently greatly reducing the cost of each circuit board.

It is understood that the drawing only represents an example provided purely as practical demonstration of the invention, which can vary in forms and arrangements without however departing from the scope of the concept underlying the invention. Any reference numerals in the appended claims are provided purely to facilitate reading of the claims with reference to the description and to the drawing, and do not limit the scope of protection represented by the claims.

1-17. (canceled)

18. A device for electrically connecting a circuit board to an external programmer, comprising:
a support;
a plurality of retractable electrical contacts positioned according to a predetermined arrangement and carried by the support;
a connector electrically connected to the plurality of retractable electrical contacts;
a coupling and guiding assembly configured for guided coupling of the connection device to a circuit board; and
the coupling and guiding assembly further comprising at least one pin rigidly constrained to the support, the pin aligned substantially parallel to the plurality of retractable electrical contacts.

19. The device of claim 18, wherein each of the plurality of retractable electrical contacts are substantially parallel to one another.

20. The device of claim 18, wherein:
each of the plurality of retractable electrical contacts comprises a casing and rod housed in the casing; and
the device further comprises an elastic member associated with each rod and configured to elastically force the rod to project from the respective casing constrained to the support; and
each rod is configured to retract toward an inside of a respective casing when biased by an external force that overcomes the elastic force applied to the rod.

21. The device of claim 18, wherein the coupling and guiding assembly comprises at least two pins rigidly constrained to the support, substantially parallel to the retractable electrical contacts.

22. The device of claim 21, wherein the at least two pins are arranged asymmetrically to inhibit prevent incorrect coupling between a circuit board and the device.

23. The device of claim 18, wherein the plurality of retractable electrical contacts are arranged according to an array, forming one or more rows of retractable electrical contacts parallel to one another.

24. The device of claim 23, wherein the plurality of retractable electrical contacts are arranged according to at least two parallel rows, and wherein each row comprises one of the at least two pins rigidly constrained to the support, the pins being staggered in relation to one another.

25. The device of claim 18, wherein the support comprises a plurality of seats configured to house the plurality of retractable electrical contacts, and wherein the number of plurality of seats is greater than the number of retractable electrical contacts, to enable the arrangement of the plurality of retractable electrical contacts to be configured in a variable manner.

26. An electrical assembly comprising:
a circuit board comprising at least one electronic component programmable via an external programmer, a plurality of solder pads corresponding to programming terminals of the programmable electronic component, positioned according to a predetermined arrangement and forming electrical contact surfaces; and at least one through hole associated with the solder pads; and
a connector device for electrically connecting the circuit board to an external programmer, the device comprising
a support,
a plurality of retractable electrical contacts positioned according to a predetermined arrangement and carried by the support,
a connector electrically connected to the plurality of retractable electrical contacts,
a coupling and guiding assembly configured for guided coupling of the connection device to a circuit board, and
the coupling and guiding assembly further comprising at least one pin rigidly constrained to the support, the pin aligned substantially parallel to the plurality of retractable electrical contacts.

27. The assembly of claim 26, wherein the circuit board comprises at least two through holes associated with the solder pads.

28. The assembly of claim 27, wherein the solder pads and the at least two through holes are arranged according to an asymmetrical configuration.

29. The assembly of claim 26, wherein the circuit board is arranged in an electrical device having a housing and at least a portion of the circuit board is accessible from outside of the housing.

30. An electrical system comprising:
a programmer having a programmer connector comprising a first series of electrical contacts;
a connector device comprising
a support,
a plurality of retractable electrical contacts positioned according to a predetermined arrangement and carried by the support,
a device connector electrically connected to the plurality of retractable electrical contacts, and
a coupling and guiding assembly configured for guided coupling of the connector device to a circuit board, the coupling and guiding assembly further comprising at least one pin rigidly constrained to the support, the pin aligned substantially parallel to the plurality of retractable electrical contacts; and
the programmer connector configured to being electrically couplable to the connector device.
